(19) United States
(12) Patent Application Publication
(10) Pub. No.: US 2011/0198133 A1
(43) Pub. Date: Aug. 18, 2011

(54) Space saver bathroom scale

(76) Inventor: Taiming Chen, Fremont, CA (US)

(21) Appl. No.: 12/931,400

(22) Filed: Feb. 1, 2011

Related U.S. Application Data
(60) Provisional application No. 61/337,858, filed on Feb. 12, 2010.

(51) Int. Cl. G01G 19/44

(52) U.S. Cl. 177/244

(57) ABSTRACT

Disclosed herein is a bathroom scale. The scale is comprising of a scale body member and a scale footing member. Said scale footing member connected to said scale body member movably toward and away there from. Said footing member provides a first ground contact surface facing downward for said scale to stay flat on ground. Said scale also has a handle on one side of scale body and a second ground contact surface on a different side of scale body. Said second ground contact surfaces faces sideway when scale stay on its first ground contact surface. User can pick up presenting scale via its handle and let it stay on said second ground contact surface and stand vertically by itself.

### CROSS-REFERENCE TO RELATED APPLICATIONS

This application is related to and claims priority from U.S. Provisional Patent Application Ser. No. 61/337,858 filed on Feb. 12, 2010. The content of the Application is incorporated into present invention as a part of the specification.

### BACKGROUND OF THE INVENTION

Traditional bathroom body weight scale stands flat to provide a stand-on platform for user to stand on in order to measure body weight. However, it also occupies larger floor space whether being used or not. This space saver scale has two standing positions. One is just like traditional scales stay flat on floor, and the other position stands vertically to save floor space while not in use.

### DESCRIPTION OF PRIOR ART

U.S. Pat. No. 3,097,966 to Mike Provi describes a bathroom scale with a base and hinge to swim between horizontal and vertical positions. It does not have a second footing surface integrated with its body to stand along by itself.

U.S. Pat. No. 3,481,415 to W. Y. Hutchinson describes a bathroom scale with hand carrying hole in platform. However, it's for carrying and it does not have a second footing surface to stand on.

### SUMMARY OF THE INVENTION

A body weight scale that has two standing positions. The scale can stand flat with display and stand-on surface point upward in order to take user's body weight, just like traditional bathroom body weight scales. It also has a handle at one end for gripping on; and a convex outer surface on the opposite end that can face downward to ground as footing. When a said scale is not being used, user can lift the scale via its handle till it's vertical, and it can stand vertically so the scale occupies much less floor space.

### BRIEF DESCRIPTION OF THE DRAWINGS

FIG. 1 is a perspective view of said scale. It has an integrated hollow indent, 1, which functions as a grip handle, and a side footing surface, 2. The dial display, 3, is facing upward.

FIG. 2 is a perspective view of said scale, from a different point of view than FIG. 1.

FIG. 3 is a side view shows said scale stand flat as horizontal position.

FIG. 4 is a side view shows said scale stand on its side as vertical position.

### DETAILED DESCRIPTION OF THE PREFERRED EMBODIMENT

Prior to the more detailed description of the present invention, it should be noted that, for the sake of clarity and understanding, identical components which have identical functions have been identified with identical reference numerals throughout the several views illustrated in the drawing figures.

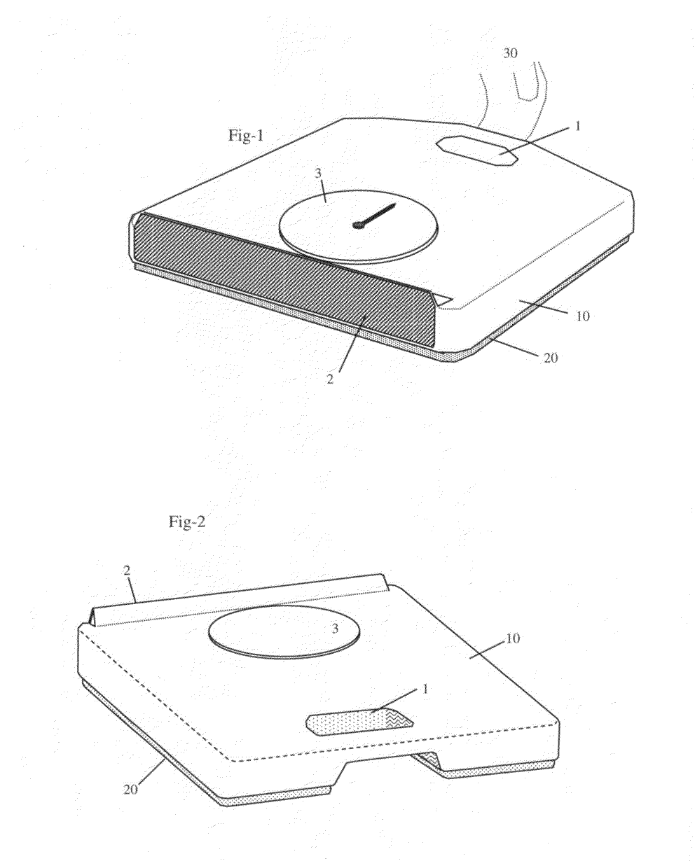

FIG. 1 shows a bathroom scale has a body member 10 and footing member 20. The force applied between them is measured and displayed on scale display 3. On one side of scale, there is a handler 1 where user's hand 30 can pick up and lift one side of scale or carry entire scale off ground. There is a second ground contact surface 2 facing sideway when scale footing member 20 stay flat on ground.

FIG. 2 shows said handle 1 is formed by dent of contour of scale body member and scale footing member 20.

FIG. 3 shows scale stays flat or horizontally on ground, its first ground contact surface 4 makes contact to ground. In this position, scale body member 10 forms a platform for user to stand on to measure body weight. Scale handle 1 provide a pick up mean for user's hand 30 to pick up one end or entire of scale.

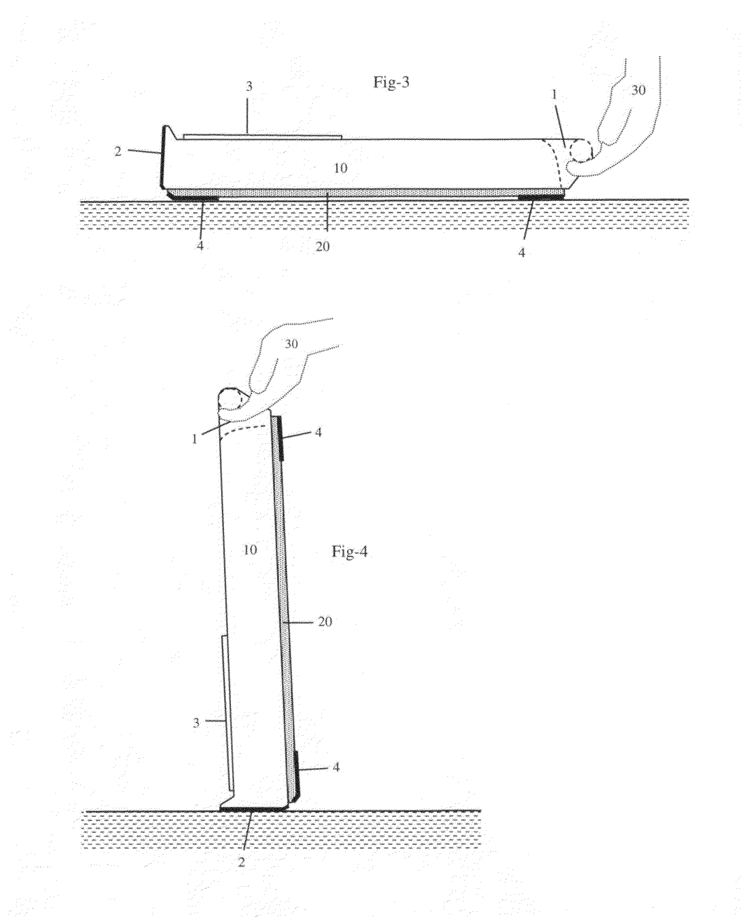

FIG. 4 show user's hand 30 lift the scale to vertical position and presenting scale can stand alone on its second ground contact surface 2. In this position, scale required a lot less floor space than horizontal position.

I claim:

1. A scale, comprising:
(a) a scale body member,
(b) a scale footing member connected to said scale body member movably toward and away there from, said footing member provides a first ground contact surface facing downward for said scale to stay flat on ground,
(c) a handle on one side of scale body,
(d) a second ground contact surface on a different side of scale body, said second ground contact surface faces sideway when scale stay on its first ground contact surface of footing member; entire scale can stay on said second ground contact surface and stand vertically.

2. The scale of claim 1, wherein: said handle position at far side of said second ground contact surface, therefore when handle side raised high by user, said second ground contact surface could face downward.

3. The scale of claim 1, wherein: said handle is integrated dent contour on said scale body member that allows user to grip on.

4. The scale of claim 1, wherein: said handle is integrated dent contour on said scale footing member that allows user to grip on.

5. The scale of claim 1, wherein: said second ground contact surface is on a extension of said scale footing member.

6. The scale of claim 1, wherein: said second ground contact surface is on a extension of said scale body member.

7. The scale of claim 1, wherein: said scale has a round edge between first and second ground contact surfaces for easy rolling between vertical and flat positions.
